(19) United States
(12) Patent Application Publication
(10) Pub. No.: US 2005/0242541 A1
(43) Pub. Date: Nov. 3, 2005

(54) Rigid axle for a vehicle, comprising integrated trailing arms and mounting brackets

(76) Inventor: Paul Griffiths, Chester (GB)

Correspondence Address: KLAUS J. BACH, 4407 TWIN OAKS DRIVE, MURRYSVILLE, PA, 15668, US

(21) Appl. No.: 11/032,501

(22) Filed: Jan. 10, 2005

Related U.S. Application Data
(63) Continuation-in-part of application No. PCT/EP03/05683, filed on May 30, 2003.

(30) Foreign Application Priority Data
Jul. 11, 2002 (DE) 102 31 376.8

(51) Int. Cl. B60G 1/04

(52) U.S. Cl. 280/124.11

(57) ABSTRACT

In a rigid axle for a vehicle, comprising an axle body, on whose ends wheel carriers are arranged, and at least two trailing arms that are fixed to the axle body, the respective free end of a first section of the corresponding trailing arm being mounted in an articulated manner on a vehicle bearing block, while the free end of a second section that extends beyond the axle body is configured as a spring bracket and is supported on the vehicle body bearing block via at least one spring element, the axle body has, for each wheel side, a flange face with bores, to which a spring bracket can be adjustably mounted by means of separate mounting elements that extend through the bores so as to facilitate adaptation to various vehicles.

This is a Continuation-In-Part Application of International Application PCT/EP03/005683 filed May 30, 2003 and claiming the priority of German application 102 31 376.8 filed Jul. 11, 2002.

### BACKGROUND OF THE INVENTION

The invention relates to a rigid axle for a vehicle, comprising an axle housing, on whose ends axle journals or wheel carriers are arranged, and at least two trailing arms which are fixed to the axle housing in a rigid manner, the respective free end of a first section of the corresponding trailing arm being mounted in an articulated manner on the vehicle body, while the vehicle body is supported on the free end of a second section that extends beyond the axle and is configured as a spring bracket, by at least one spring element.

DE 198 18 698 A1 discloses such a rigid axle for a vehicle, which comprises an axle tube and trailing arms arranged thereon. The individual trailing arm is extended rearward beyond the axle tube, forming a spring bracket. Its free end there is used as a support for an air spring. The spring bracket and the axle tube are configured in the common mounting joint in such a way that the spring bracket can be displaced vertically relative to the axle tube. Once an individual position of the spring bracket, for example matched to a specific vehicle, has been set, the bracket is welded to the axle body. In this way, the vehicle can be designed, for example, for a particular ground clearance desired by a customer.

U.S. Pat. No. 5,954,351 discloses a suspension for air-sprung vehicle axles. In this case, guide arms are connected to an axle body that carries vehicle wheels, are attached to a vehicle body at their leading end in the direction of travel and, at their rear end, form a support for an air spring. For this purpose, the rear end of the guide arm has a large number of holes, via which the air spring is attached to the guide arms.

It is the object of the present invention to provide a rigid axle for a vehicle including components which facilitate adaptation to various automotive and/or towed vehicles. The variants predefined by the components are intended to be produced only during the final mounting.

### SUMMARY OF THE INVENTION

In a rigid axle for a vehicle, comprising an axle body, on whose ends wheel carriers are arranged, and at least two trailing arms that are fixed to the axle body, the respective free end of a first section of the corresponding trailing arm being mounted in an articulated manner on a vehicle bearing block, while the free end of a second section that extends beyond the axle body is configured as a spring bracket and is supported on the vehicle body bearing block via at least one spring element, the axle body has, for each wheel side, a flange face with bores, to which a spring bracket can be adjustably mounted by means of separate mounting elements that extend through the bores so as to facilitate adaptation to various vehicles.

Rigid axles of this type for vehicles are used, inter alia, as trailer axles for heavy commercial vehicles. Within such an axle, the trailing arms, as viewed in the direction of travel, are divided behind the axle tube or axle body. The front part comprises, for example, a shaped part which is complex and whose shape is optimized and which can be used to the same extent for all variants. Together with the axle tube, it forms a functional unit which supports the multi-axle static and dynamic vehicle loads, lateral and transverse forces in a dimensionally rigid manner on the vehicle body. In addition, the front part also has a stabilizer function.

Individual parts generally used in pairs, such as the axle body section, trailing arm section and wheel head section are assembled in accordance with the track width and permissible axle load and, for example, in each case welded to one another at the end by friction welding. During assembly, for example in order to configure an axle for a trailer whose track width is greater than the standard track width, a longer axle body can be used. Instead of the longer axle body, if the frame width is unchanged, longer axle journals or wider trailing arm sections can also be used.

By means of welding sections at their ends, doubling of material in the welding zone is avoided. In this way, the axle weight is reduced without any loss of strength. In addition, the formation of corrosion is reduced as a result of avoiding overlapping joints and gaps, and weld testing is made easier. The reduction in weight reduces the unsprung axle mass and thus, inter alia, moderates the tendency of the rigid axle to tramp. The latter improves ground adhesion and thus driving safety. This also has a positive effect on the service life of the tires.

The rear part of the axle, which is represented by the respective second section of the trailing arms, is likewise specific to the vehicle. It is designed as a relatively simple spring bracket. As compared with the front part of the axle, this spring bracket has to absorb only relatively low, normally single-axle, loads. Consequently, it can be produced, for example, from more economical materials and/or with simpler fabrication methods. The brackets can be injection moldings, shaped sheet-metal parts, simple welded constructions or forged parts. Since they are fixed only during final mounting, that is to say only to the finally painted axle body, by means of simple mounting means such as rivets or bolts, coordination of materials necessary to a certain extent during welding is not necessary. For example, in each case a spring bracket of fiber reinforced plastic for each wheel side can be mounted on a steel axle body.

In order also to ensure adaptation to different rim depths and/or tire widths, more fixing holes than necessary are made on the axle body for each wheel side, so that the distance between the brackets and the center of the vehicle can be varied in one or more steps.

Furthermore, different brackets are available with respect to the geometric shape for different vehicle types.

The invention will become more readily apparent from the following description of preferred embodiments thereof on the basis of the accompanying drawings.

### BRIEF DESCRIPTION OF THE DRAWINGS

FIG. 1 shows the outer part of a rigid axle for a vehicle in a perspective illustration;

FIG. 2 shows a mounting bracket with a double reinforcement web;

FIG. 3 shows a mounting bracket with a single reinforcement web;

FIG. 4 shows a mounting bracket with a peripheral flange; and

FIG. 5 shows a hole pattern for each wheel side of the rigid axle.

### DESCRIPTION OF PREFERRED EMBODIMENTS

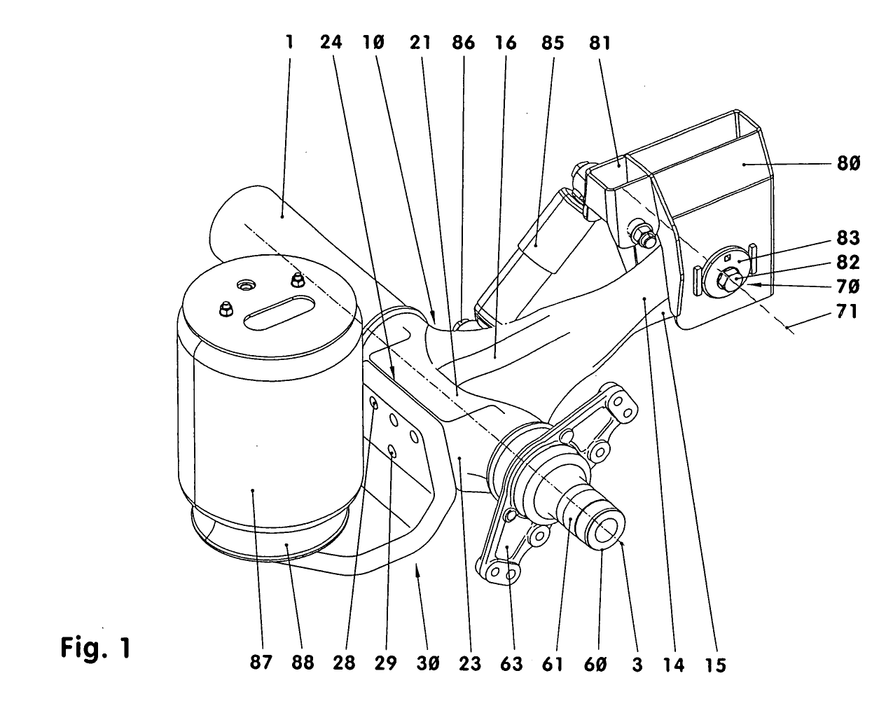

FIG. 1 shows by way of example a right outer region of a towed commercial vehicle trailer or semi trailer, without wheel or brake.

According to FIG. 1, the axle part illustrated comprises an axle body section 1, a right-hand trailing arm section 10 and a wheel head section 60. At its leading end, for example pointing in the direction of travel, the trailing arm section 10 is fixed such that it can be pivoted in a manner of a cardan joint in an articulated bearing arrangement 70 by means of an elastomer body in a bearing block 80 mounted on the vehicle body. It is supported with respect to the bearing block 80 by means of a shock absorber 85. The trailing end of the trailing arm section 10 is supported on the vehicle body, not illustrated, for example via a spring element 87 in the form of an air spring.

The axle body section 1 comprises, for example, a cylindrical, smooth axle tube. The axle tube( ), which can also be a polygonal profile, ends in the embodiment shown directly at the trailing arm section 10 with a straight, flat end face. The end face is aligned normally with respect to the center line 3 of the axle tube 1.

The trailing arm section 10 comprises, in functional terms, a central element 21 and an arm segment 14 having a joint eye, hidden here by the bearing block 80. The central element 21 is drum-shaped and has two lateral, for example open, end faces. Toward the joint end, the central element 21 is followed by the arm segment 14. The two parts 21, 14 comprise, for example, a lower shell (15) and an upper shell 16 shaped from steel sheet. The two shells 15, 16, for example, are designed mirror-symmetrically with respect to each other and are welded to each other. The welded joint lies, for example, in a plane which is covered by the axle tube center line 3 and the center line 71 of the joint bearing 70.

The arm segment 14 has, for example, a cross section that varies over its entire length. In the region of the central element 21 it has at least approximately an elliptical cross section, the large major axis of the ellipse being located parallel to the axle tube center line 3. The large semi axis is approximately 2.3 times larger than the small semi axis. In the region of the joint end, the cross section is oval, the vertical extent being about two to three times larger than the horizontal transverse extent. Between these two outer regions, at approximately half the length of the shell, there is a central region which has a virtually round cross section.

The aforementioned cross section in the region of the central element 21 is, for example, 5.5 times larger than the cross section in the region of the joint eye. The virtually round cross section located in the central region is, for example, 4.6 times smaller than the cross section in the region of the central element 21.

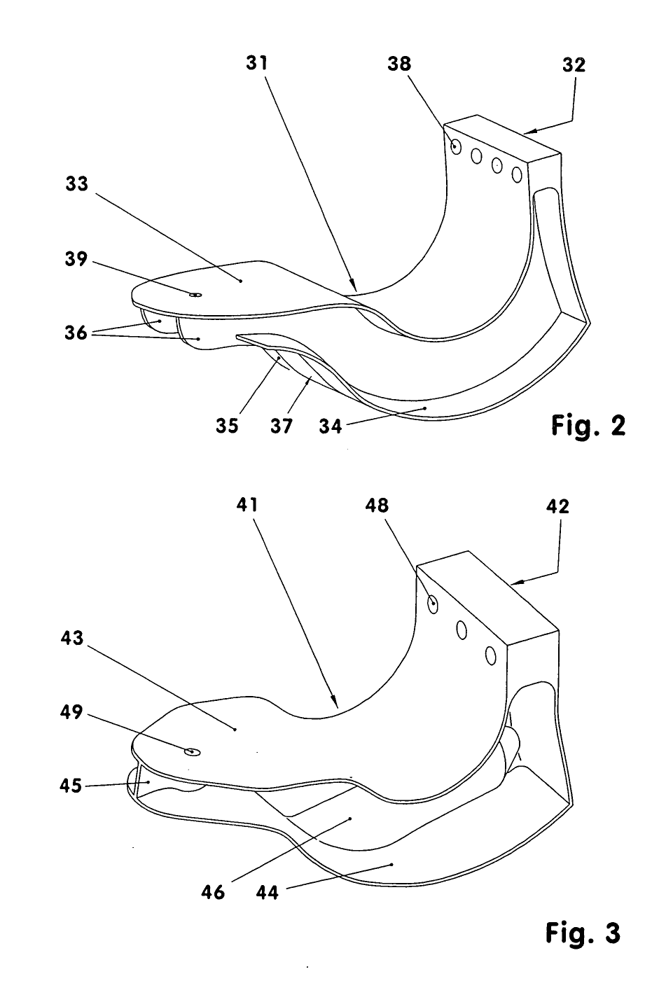

On the side facing away from the arm segment 14, the central element 21 has a supporting lug 23, as it is known. In the plane of the drawing according to FIG. 2, the latter has a trapezoidal contour with, for example, one flange face 24. The flange face 24, for example at least in its central region, is aligned normally with respect to a connecting line which represents the shortest connection between the center lines (3) and (71). The spring bracket 30, 31, 41, 51 is adapted, in cross section, to the supporting lug 23 which can also be triangular, for example, and to the flange face 24.

The spring bracket 30 according to FIG. 1 is a bracket, illustrated schematically, for connecting the rigid axle to the spring element 87. It is fixed permanently, for example via five rivets 28, 29, for example blind or explosive rivets, of which only four are illustrated, in two rows on the central element (21). The four rivets 28 of the upper row 26, cf. FIG. 5, bear the main load of the connection between the rigid axle and the bracket 30 in normal vehicle operation. The rivet 29 of the lower row 27, cf. FIG. 5, is in principle stressed only during spring extension.

FIGS. 2 to 4 show different types of spring and mounting brackets 31, 41, 51. All three brackets 31, 41, 51 have, for example, a curved adapter face 32, 42, 52. The curvature corresponds to a section of a shell of a cylinder, when the bracket 31, 41, 51 is mounted, the center line of the corresponding cylinder running parallel to the center line (3) and, for example, being located in the region between the center lines 3 and 71.

The spring bracket 31 according to FIG. 2 is shaped as a curve profiled support. The mounting bracket 31 comprises an upper large part subjected to tension, a flat flange 33 which is shaped like a sickle and which extends over the entire component width. Underneath the flange 33 there are two part flanges 34, 35, which extend as far as the rear adapter face 32. Between the upper flange 33 and the lower part flanges 34, 35 there are arranged at least two approximately vertically aligned, for example parallel, webs 36 which connect the flanges, at least in some regions. The web height in the middle of the mounting bracket 31 is approximately twice as high as at the free bracket end facing away from the adapter face 32. At the said bracket end, the webs 36 project beyond the part flanges 34, 35 by a length which corresponds approximately to the web height.

In the region of the adapter face 32, there is also a rear flange between the webs 36, so that the adapter face (32) forms an uninterrupted curved face, with the exception of the fixing recesses and holes. In the upper zone of the adapter face 32 there are four holes 38. Underneath these holes 38, arranged centrally in relation to the adapter web, is a fifth hole, not visible here, cf. rivet 29 from FIG. 1. This hole lies between the webs 36. The corresponding rivet 29 can be inserted into the central hole with the riveting tool via the clearance 37 located between webs 36 and can be riveted there.

Machined into the free end of the upper flange 33 is a hole 39. The latter is used for fixing the spring element 87 used. In FIG. 2, the adapter face 32 and the spring element support face located around the hole 39 form an angle of less than 90°. The angle is specified on the adapter face 32 in relation to a tangential plane which makes contact approximately at the central level of the adapter face 32. A plane lying in the spring element support face intersects the adapter face 32 approximately at half the height.

The mounting brackets 31, 41, 51 rest with their entire area on the supporting lug 23, at least in the area covered by the holes 28, 29, irrespective of their curvature or arching. The matched curves of the flange face 24 and adapter faces 32, 42, 52 can also be spherical. The center or centers of curvature then also lie, for example, in the region in which the center line of the previously described cylindrical curvature is located.

The spring bracket 41 according to FIG. 3 has in each case a continuous upper flange 43 and a likewise virtually full-area lower flange 44. The two flanges 43, 44 have approximately the same area and are connected to each other over their entire length by a vertical web 45. The web height increases starting from the free end toward the adapter face 42. Over about two thirds of the bracket length, between the web 45 and the lower flange 44, there is a tubular web 46. The tubular web 46 connects a lower bore area—for the rivet 29 from FIG. 1—to a large, approximately elliptical or oval opening area in the lower flange 44. Its outer contour tapers in the manner of a truncated cone, for example over the last fifth of its total length. On the inside, the tubular web 46 has the contour of a two-stage bore. The larger front region is for example shaped in the manner of a truncated cone. The region of the hole having the smaller diameter accommodates the lower rivet or screw.

In the mounting bracket 41, the physical arrangement of the spring element supporting face surrounding the hole 49 corresponds approximately to that of the bracket 31. However, the bracket 41 is narrower than the bracket 31. In addition, it has only three bores 48 in the upper region.

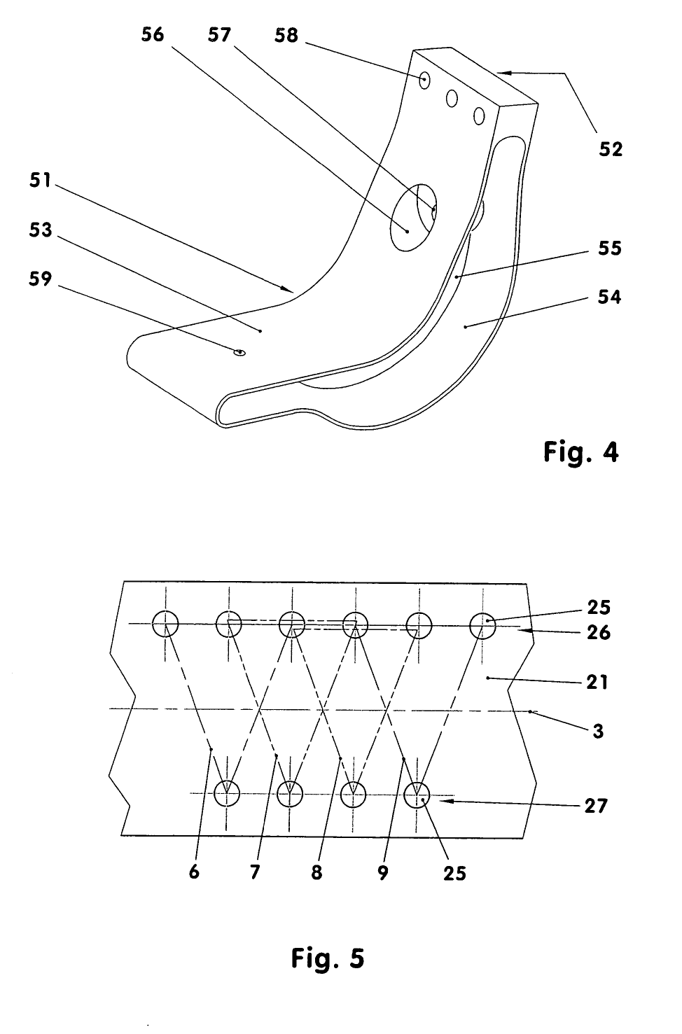

The spring bracket 51 according to FIG. 4 is shaped largely as a curved I beam. The I beam comprises an upper, flat flange 53 largely subjected to tension and curved in the shape of a sickle, a comparable lower flange 54 loaded more in compression, and a central web 55 which connects the two flanges 53, 54, at least in some sections. At the free end of the bracket 51, the flanges 53, 54 merge seamlessly and tangentially into each other in a half-round curve. Around the region of the bore 59, the two flanges 53, 54 have a constant spacing. Toward the adapter face 52, the web 55 broadens by about twice or three times the web height in the vicinity of the bore. Toward the supporting lug 23, the lower flange 54, as opposed to the bracket 30, 31, 41, merge is smoothly curved to continuously into the full-area adapter face 52.

For the purpose of fixing the bracket 51 by means of a lower rivet 29, the upper flange 53 is provided for example in its upper third with a cylindrical recess 56 which is cylindrical or shaped in the manner of a truncated cone or the like and has a flat base. In the center of the recess 56 there is a bores 57. By providing the recess 56, the upper and lower rivets 28, 29 or comparable screws can have the same overall size.

The face of the lower flange 54 that acts as an adapter face 52 forms an angle of more than 90° with the spring element supporting face around the bore 59. The angle is 120°, for example. In addition, the plane in which the spring element supporting face extends intersects the lower flange 54 underneath the contour acting as adapter face 52.

The respective spring bracket 31, 41, 51 is fixed to the central element 21 via, for example, four or five rivets 28, 29. According to FIG. 5, for this purpose there are in the central element 21, for example six holes in an upper 26 row and four holes in a lower row 27 of holes. This bore pattern is designed for a bracket 41, 51 having four bores 48; 57, 58. In each case three bores in the upper row 2 with a fourth bore from the lower row 27 belong to a bore pattern group 6-9. In each case one bore pattern group is available for positioning the corresponding bracket 41, 51 on the central element 21. Therefore, depending on the axle design, the brackets 41, 51 for each wheel side are able to assume four different positions, each position having a different spacing with respect to the axle center. The bores that are not needed are closed, for example by means of plastic or rubber plugs.

According to FIG. 1, an axle journal 61 is arranged beside the trailing arm section 10 in the extension of the axle tube center line 3. The axle journal is substantially a rotationally symmetrical part for mounting the wheel, which has one end face oriented normal with respect to the center line 3 toward the trailing arm section (10). In the vicinity of this end face, a brake carrier flange 63 is integrally molded on the axle journal 61.

The axle tube 1, the trailing arm sections 10 and the axle journals 61 are all arranged in axial alignment with one another. The axle tube 1 is butt-welded to the inner arm face of the trailing arm section 10, and the axle journal 61 is butt welded to the outer end face. The welding method used is, for example, friction welding.

Depending on the axle, the axle tube 1 arranged between the trailing arm sections 10 can also be omitted. In this case, the inner end faces of the central elements 21 are welded directly to each other. If necessary, the central element is lengthened toward the center of the axle for this purpose.

The trailing arm section 10 is mounted in the bearing block 80 by means of an elastomer body, not illustrated. The latter is seated in the joint eye, for example pressed in. The elastomer body is fixed in the bearing block 80 with the aid of a bolt 82. The bolt (82) is supported on the bearing block (80) at both ends in eccentric washers 83 between lateral stops for adjusting the track.

On the bearing block 80, toward the axle, there is a box-like projection 81. Between this projection (81) and the screw 86 arranged in the bottom region of the arm segment 14, a shock absorber 85 is installed.

1. A rigid axle for a vehicle body comprising an axle body (1),
having opposite ends with wheel carriers arranged at its opposite ends,
at least two trailing arms (10) fixed rigidly to the axle body, and having
a first section mounted in an articulated manner on a bearing block (80) of the vehicle body, a second section with
a free end extending beyond the axle body (1) and forming a spring bracket for supporting the vehicle body via at least one spring element (87),
the axle body (1) having for each wheel carrier end a flange face (24) with corresponding bores (25), to which in each case a spring bracket (30; 31; 41; 51) can be adapted in a rigid manner by means of separate fixing elements (28; 29) that extend through the bores (25).

2. The rigid axle for a vehicle as claimed in claim 1, wherein, for each wheel side, the axle body has more bores (25) than are needed for the mounting of a spring bracket (30; 31; 41; 51).

3. The rigid axle for a vehicle as claimed in claim 2, wherein a specific subset of bores (25) forms a group (6-9) needed for the adaptation, the sum of all the bores (25) comprising at least two groups.

4. The rigid axle for a vehicle as claimed in claim 1, wherein each half of the rigid axle—viewed from the center of the axle—comprises an axle body section (1), a trailing arm section (10) and a wheel head section (60) arranged one after another, the wheel head section (60) comprising at least an axle journal (61) or a wheel carrier.
